(19) United States
(12) Patent Application Publication
(10) Pub. No.: US 2020/0012435 A1
(43) Pub. Date: Jan. 9, 2020

(54) AGGREGATION OF MANAGEMENT INFORMATION IN A DISTRIBUTED STORAGE NETWORK

(71) Applicant: International Business Machines Corporation, Armonk, NY (US)

(72) Inventors: Patrick A. Tamborski, Chicago, IL (US); Bart R. Cilfone, Marina del Rey, CA (US); Alan M. Frazier, Palatine, IL (US); Sanjaya Kumar, South Elgin, IL (US)

(21) Appl. No.: 16/026,978

(22) Filed: Jul. 3, 2018

(51) Int. Cl. G06F 3/06

(52) U.S. Cl. CPC G06F 3/0607; G06F 3/067; G06F 3/0653

(57) ABSTRACT

A method for coordinating the aggregation of management information in a distributed storage network begins with a processing module in a designated storage unit/storage node receiving management information from other storage units/nodes at a first storage site and generating aggregated management information for management information received from the storage units. The method continues with the processing module transmitting the aggregated management information to a processing module associated with a second designated storage unit that is at another storage site or is associated with another set of storage units within the first storage site. After receiving the aggregated management information, generates further aggregated management information with management information received from other storage sites and transmits the further aggregated management information to a processing module associated with a third designated storage unit, which can aggregate the further aggregated management information with additional aggregated management information.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### BACKGROUND OF THE INVENTION

### Technical Field of the Invention

This invention relates generally to computer networks and more particularly to distributed storage networks.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

When individual storage devices are either added to or removed from the DSN, or when encoded data slices are being rebuilt, significant communication traffic may be required between the devices within a set of encoded data slices. In most cases extraneous communication of management information is not desirable. A management information coordinator can be used to aggregate management information for transmission to a higher-level manager/aggregator.

### BRIEF DESCRIPTION OF THE SEVERAL VIEWS OF THE DRAWING(S)

FIG. 1 is a schematic block diagram of an embodiment of a dispersed or distributed storage network (DSN) in accordance with the present invention;

FIG. 2 is a schematic block diagram of an embodiment of a computing core in accordance with the present invention;

FIG. 3 is a schematic block diagram of an example of dispersed storage error encoding of data in accordance with the present invention;

FIG. 4 is a schematic block diagram of a generic example of an error encoding function in accordance with the present invention;

FIG. 5 is a schematic block diagram of a specific example of an error encoding function in accordance with the present invention;

FIG. 6 is a schematic block diagram of an example of a slice name of an encoded data slice (EDS) in accordance with the present invention;

FIG. 7 is a schematic block diagram of an example of dispersed storage error decoding of data in accordance with the present invention;

FIG. 8 is a schematic block diagram of a generic example of an error decoding function in accordance with the present invention;

FIG. 9 is a schematic block diagram of an example of a multi-tier configuration for coordinating the collection and aggregation of management information for storage devices in a DSN in accordance with the present invention;

FIG. 10A is a schematic block diagram of an example of a storage unit for a distributed storage network in accordance with the present invention;

FIG. 10B is a schematic block diagram of an example storage site illustrating an example embodiment of the communication between storage sets within a storage site in accordance with the present invention; and

FIG. 11 is an example logic diagram of a method for coordinating the aggregation of management information in a distributed storage network in accordance with the present invention.

### DETAILED DESCRIPTION OF THE INVENTION

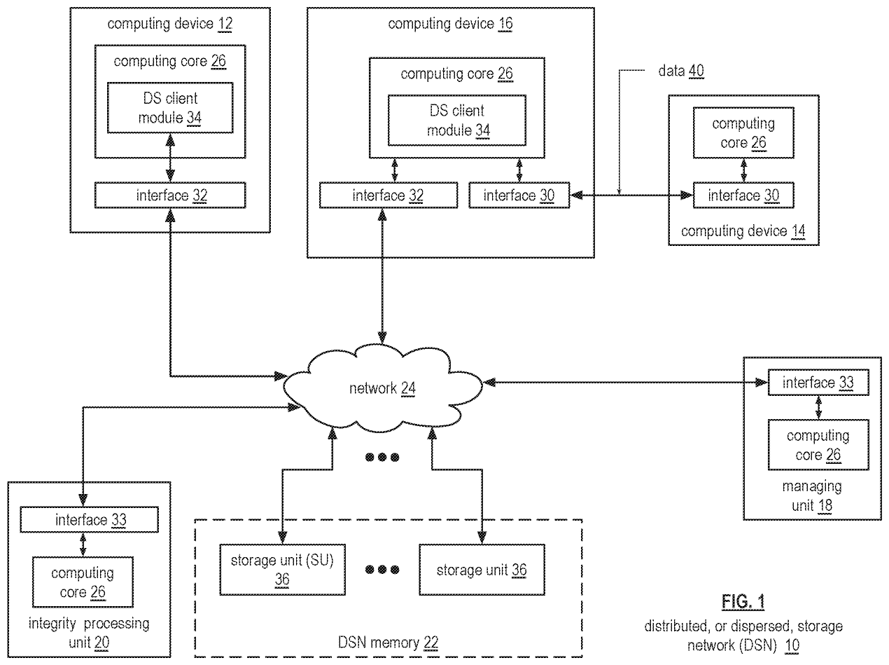

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public interne systems; and/or one or more local area networks (LAN) and/or wide area networks (WAN).

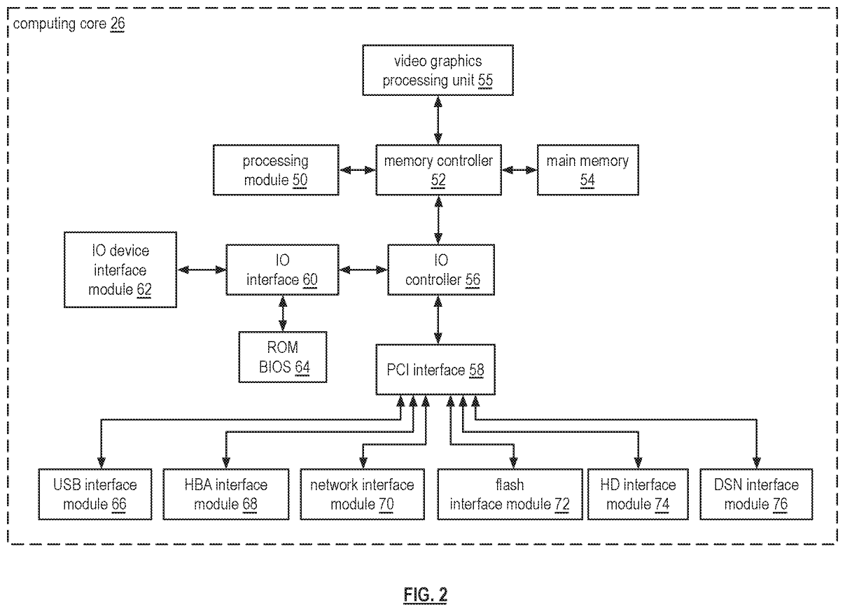

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed error encoded data.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 and 16 and the DSN memory 22. As yet another example, interface 33 supports a communication link for each of the managing unit 18 and the integrity processing unit 20 to the network 24.

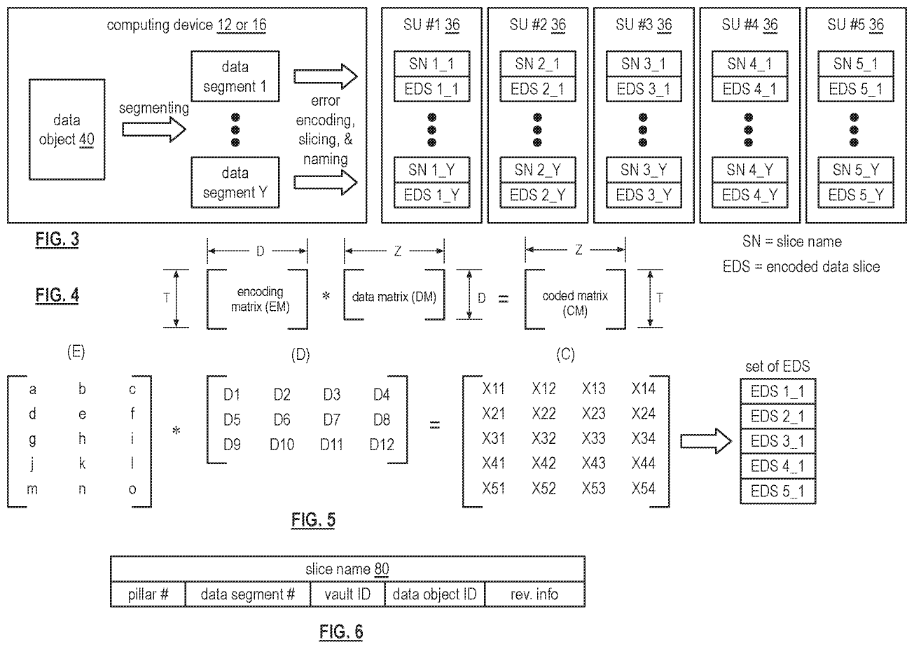

Computing devices 12 and 16 include a dispersed storage (DS) client module 34, which enables the computing device to dispersed storage error encode and decode data (e.g., data 40) as subsequently described with reference to one or more of FIGS. 3-8. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The managing unit 18 creates billing information for a particular user, a user group, a vault access, public vault access, etc. For instance, the managing unit 18 tracks the number of times a user accesses a non-public vault and/or public vaults, which can be used to generate a per-access billing information. In another instance, the managing unit 18 tracks the amount of data stored and/or retrieved by a user device and/or a user group, which can be used to generate a per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSN memory 22.

FIG. 2 is a schematic block diagram of an embodiment of a computing core 26 that includes a processing module 50, a memory controller 52, main memory 54, a video graphics processing unit 55, an input/output (IO) controller 56, a peripheral component interconnect (PCI) interface 58, an IO interface module 60, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the IO device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment (i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

Returning to the discussion of FIG. 3, the computing device also creates a slice name (SN) for each encoded data slice (EDS) in the set of encoded data slices. A typical format for a slice name 80 is shown in FIG. 6. As shown, the slice name (SN) 80 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

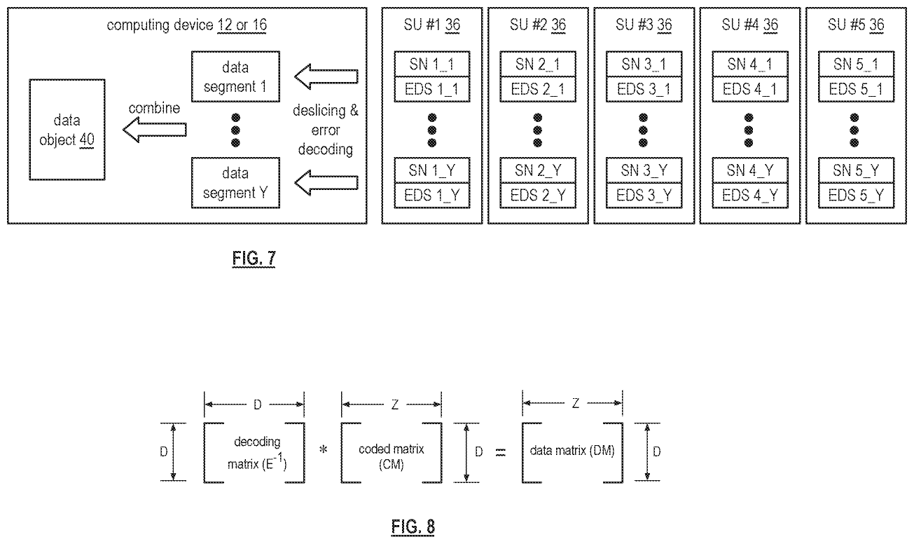

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

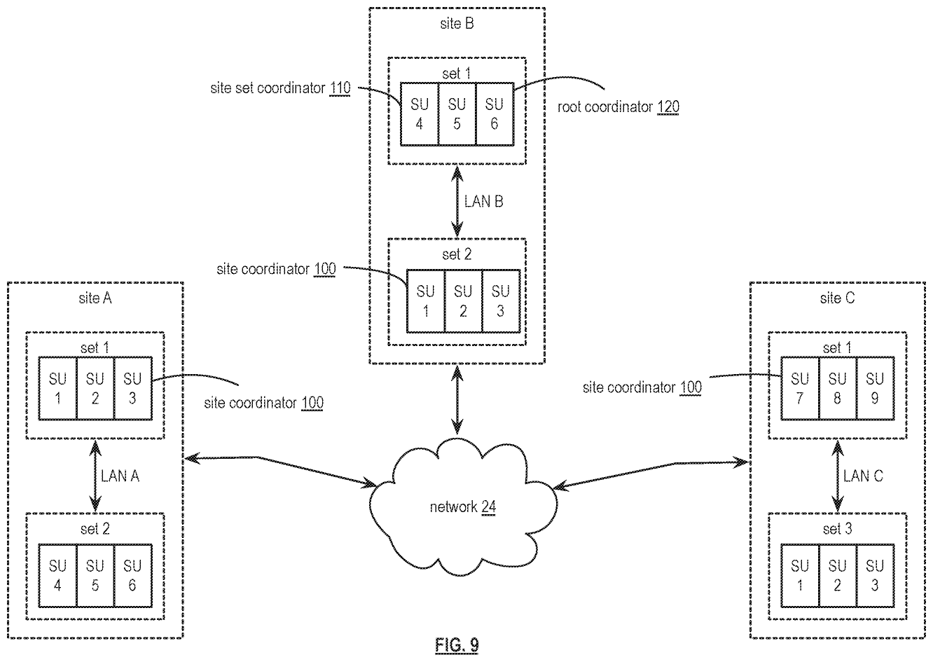

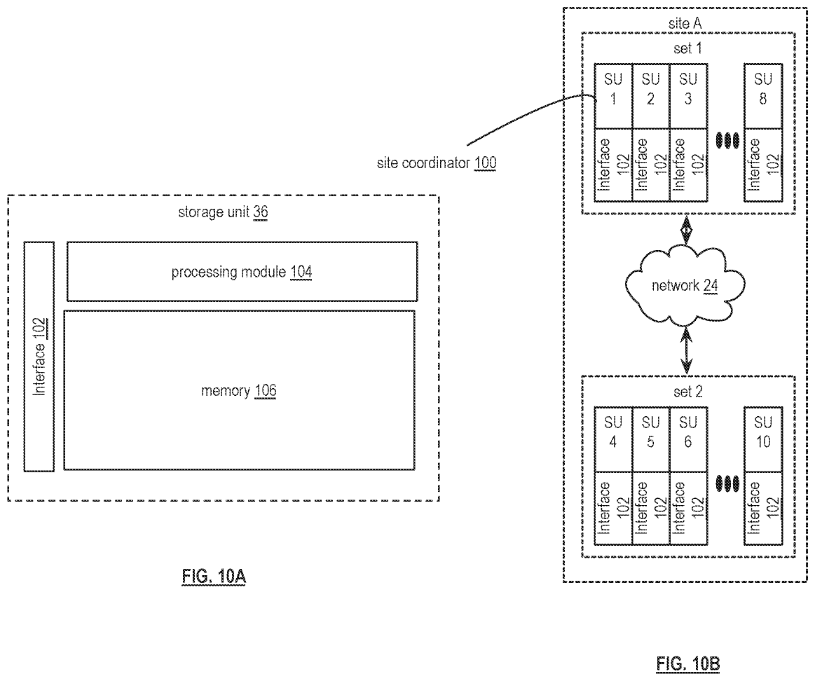

When individual storage devices are either added to or removed from the DSN, or when encoded data slices are being rebuilt, significant communication traffic may be required between the devices within a set of encoded data slices. In most cases extraneous communication of management information is not desirable. FIG. 9 is a schematic block diagram of an example of a multi-tier configuration for coordinating the collection and aggregation of management information for storage devices in a DSN. As illustrated in FIG. 9, a “master” at each level is designated to create either a total tabulated view of that level and/or create a partial tabulated view at the level that can then be forwarded to a higher level. A tabulated view can include state information for each of the SUs providing management information. Based on the tabulated view a master at a given level can generate an alert that can then in turn be transmitted to a higher level.

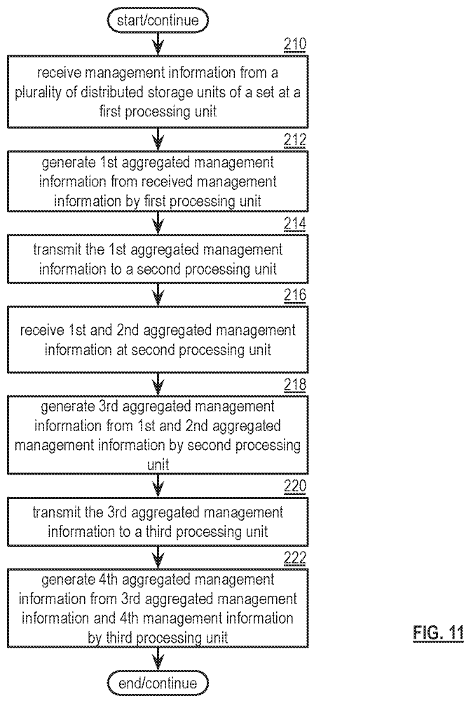

A “set-site master” (site coordinator 100) is designated for each of storage sites A B and C. Site coordinator 100 for storage site A is SU 3 (each SU is storage unit 36 from FIG. 1) from storage set 1 of storage site A. The designation of site coordinator 100 can be based on an election process, such as a defined relation for determining leader election protocols, executed by a plurality of storage units in storage site A, or alternatively by a processing module disposed elsewhere in the DSN, such as managing unit 18 from FIG. 1. Factors for the election of a given site coordinator 100 can be based on multiple factors, including performance, processing capacity and/or a rotating designation, such as a round-robin process. SU 36 is described in more detail in FIG. 10A.

Storage site A includes multiple storage sets, in this case 1 and 2, each of which can include 1 or more SUs. As illustrated, storage site A includes SUs 1, 2 and 3 from storage set 1, where storage site B includes SUs 4, 5 and 6, while storage site C includes SUs 7, 8 and 9 of storage set 1. Storage set 1 need not be distributed equally between storage sites, for example in practice all of storage set 1 can be housed in storage site A or may be distributed asymmetrically between several storage sites. In an example embodiment, site coordinator 100 receives management information for each of the SUs, including the SUs of storage set 2 in storage site A. Accordingly, storage coordinator 100 can be considered a management master for a given storage site, such as storage site A in this instance. The site coordinator 100 for storage site C is SU 7, again from storage set 1. Alternatively, the site coordinator 100 for storage site C could be elected from SUs 8 or 9 of storage set 1, or SUs 1, 2, or 3 from storage set 3. In another example embodiment each storage set, or partial storage set included in a storage site, such as storage site A, can include a set management master for that storage set, with a site coordinator 100 responsible for collecting management information from one or more set management masters.

Site coordinator 100 can aggregate management information received from the SUs in the storage site and transmit the aggregated management information via an interface and network 24 from FIG. 1 to a higher-level manager/aggregator. Aggregation may consist of collecting and forwarding the aggregated management information or may include various levels of consolidation of the aggregated management information by site coordinator 100 to reduce data traffic across the DSN.

In FIG. 9 communication between storage sets and SUs within sites A, B, and C, is facilitated by LANs A, B and C, respectively. LANs A, B, and C may be wired, optical or wireless networks or a combination of the same. In an example, all or a portion of communication between storage sets within a site, or even between SUs in a given storage set can also be across a wide area network (WAN). Site coordinator 100 forwards aggregated management information via an interface and network 24 from FIG. 1 to root coordinator 120. Storage site B includes root coordinator 120 (SU 6 from storage set 1) and site set coordinator 110 (SU 4 from storage set 1). Root coordinator 120 is designated to receive aggregated management information for each of the lower level storage units. In practice all three of coordinator 120, site set coordinator 110 and site coordinator 100 could be distributed, as illustrated, processed by a single storage unit (such as SU 6) or processed with other obvious combinations. Site set coordinator 110 is designated to process management information for all of the management information pertaining to storage set 1, regardless of which storage site it may be disposed in. The multi-tier configuration may include only site coordinators 100 and root coordinator without the use of site set coordinator 110.

The multi-tier configuration can be viewed as a logical “tree” with leaf nodes (non-master storage units) forwarding their own management information to the next higher coordination level set-site master (site coordinator 100). The multi-tier configuration, or tree, can be designed to be configurable by an operator based on a previously designated algorithm or collection of algorithms, where the operator could select the tree that is appropriate for the DSN structure and/or use case. As illustrated in FIG. 9 the root coordinator is the root master (root of the tree of masters). Additionally, one or more additional levels (not shown) of coordination may be disployed to coordinate management information from a plurality of root coordinators 120.

FIG. 10A is a schematic block diagram of an example of a SU 36 from FIGS. 1 and 9, inter alia. Each storage unit 36 can include a processing module 104, memory 106 and interface 102. Each SU 36 can be adapted to execute various DSN functions, as described with reference to FIGS. 1 and 9. Interface 102 is adapted to facilitate communication between each SU and other SUs in the storage set, along with other DSN storage and processing modules.

FIG. 10B is a schematic block diagram of an example storage site illustrating an example embodiment of the communication between storage sets within a storage site A. In the example, each of set 1 and set 2 include less than a full set of encoded data slices and SU 1 has been designated the site coordinator 100 for site A. SU 1, as site coordinator 100, coordinates the collection and aggregation of management information for each of SUs 1-8 of storage set 1 and SUs 4-10 of storage set 2. Each of SUs 4-10 of storage set 2, along with SUs 2-8 of storage transmit management information to SU 1 of storage set 1 via interface 102 using one of network 24, a combination network 24 and a local network, or using only a local network. SU 1 of storage set 1 aggregates the management information, as a tabulated view, a partial tabulated or another consolidated data collection and transmits it to the next higher coordination level.

FIG. 11 is an example logic diagram of a method for coordinating the aggregation of management information in a distributed storage network. The method begins at step 210, where a processing module in a designated storage unit/storage node receives management information from other storage units/nodes at a (first) storage site. The processing module in the designated storage unit can function as a “master” for at least some of the other storage units or “non-master” storage units in the storage site. Each non-master storage unit can be considered leaf node and the designated storage unit can be considered the next level master node. In an example, the first storage unit is responsible for management information from any storage units at the storage site associated with a set of storage units. In another example, the first storage unit is responsible for management information from all storage units associated with the storage site, regardless which set of storage units each storage unit is associated with.

The method continues at set 212, with the processing module in the designated storage unit generating aggregated management information for management information received from the storage units. The aggregated management information can be in a variety of forms, including a tabulated view of the management information for an entire storage pool, or a partial tabulated view that can be forwarded to a higher-level node for creation of the tabulated view when the storage pool included storage units in other storage sites. In step 214 an interface associated with the processing module in the designated storage unit is used to transmit the aggregated management information to a processing module associated with a second designated storage unit, where the second designated storage unit is either associated with another storage site or is associated with storage unit associated with another set of storage units within the first storage site.

The method continues at step 216, with the processing module associated with a second designated storage unit receives the aggregated management information, and at step 218 generates further aggregated management information for the storage unit(s) associated with the first storage site and for aggregated management information received from other storage sites and/or sets of storage units at the second designated storage unit. The method continues at step 220, where an interface associated with the processing module in the second designated storage unit is used to transmit the further aggregated management information to a processing module associated with a third designated storage unit, which can aggregate the further aggregated management information with additional aggregated management information, with each progressive aggregation being forwarded to a higher-level aggregator and/or DSN entity. The method can theoretically continue in this manner to higher levels as needed or desired.

Using the method of FIG. 11 the DSN and its users can abstract an overall determination of the health of storage pools within the DSN. For example, when a designated storage unit acting as a site master for the storage site (or for a or portion of a set of storage units in the storage site) is unable to determine the health of a given storage pool, the next level aggregator or master (or the subsequent aggregator) can complete the aggregation for the storage pool. As explained more fully with regard to FIG. 9 above, a master at a given level can generate alerts for storage units within that master's responsibility. In an example, masters within the multi-tier hierarchy can forward alerts to higher-level masters (instead of transmitting the alerts directly) or to an originator of a set of storage units for generation to users and/or DSN management entities. In yet another example, a master can be designated to generate alerts for each portion of a set of storage units in a given geographic location.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for execution by one or more processing modules of one or more computing devices of a dispersed storage network (DSN), the method comprises:
receiving, at a first processing module, first management information pertaining to a first dispersed storage unit (DSU) of a first set of dispersed storage units (DSUs), wherein the first set of DSUs is affiliated with a first storage site;
receiving, at the first processing module, second management information pertaining to a second DSU of the first set of DSUs;
generating, by the first processing module, first aggregated management information based on the first management information pertaining to the first DSU and the second management information pertaining to the second DSU;
transmitting, by the first processing module, the first aggregated management information to a second processing module, wherein the second processing module is configured to generate second aggregated management information for a second set of DSUs, wherein the second set of DSUs is affiliated with the first storage site;
generating, by the second processing module, third aggregated management information based on the first aggregated management information and the second aggregated management information; and
transmitting, by the second processing module, the third aggregated management information to a third processing module, wherein the third processing module is configured to generate fourth aggregated management information based on the third aggregated management information and at least one additional management information pertaining to at least one additional DSU and further wherein the third processing module is affiliated with a second common storage site.

2. The method of claim 1, wherein the management information includes at least one of:
an amount of available remaining storage capacity in a DSU,
an amount of available remaining storage capacity in a set of DSUs,
an amount of available remaining storage capacity for storage in a storage site,
performance characteristics for a DSU,
performance characteristics for a set of DSUs,
performance characteristics for a storage site,
information sufficient to determine whether a DSU is incapacitated, and
information sufficient to determine whether a DSU is likely to become incapacitated.

3. The method of claim 1, wherein the first processing module is tasked with collecting management information pertaining to a set of DSUs.

4. The method of claim 1, wherein the second processing module is tasked with collecting management information pertaining to all DSUs in a storage site.

5. The method of claim 1, wherein the fourth aggregated management information includes management information associated with the first common storage site, the second common storage site and at least a third common storage site.

6. The method of claim 1, wherein the first management information and the second management information are both associated with a first storage pool, wherein the first storage pool includes a set of encoded data slices stored in a plurality of storage sites.

7. The method of claim 6, wherein the first management information, the second management and the third management information are associated with the first storage pool.

8. The method of claim 1, wherein first processing module is associated with a second DSU of the first set of dispersed storage units.

9. The method of claim 1, wherein first processing module is associated with a DSU of a second set of dispersed storage units located at the first common storage site.

10. A dispersed storage (DS) module comprises:
a first module, when operable within a computing device, causes the computing device to:
receive first management information pertaining to a first dispersed storage unit (DSU) of a first set of dispersed storage units (DSUs), wherein the first set of DSUs is affiliated with a first storage site; and
receive second management information pertaining to a second DSU of the first set of DSUs;
generate first aggregated management information based on the first management information pertaining to the first DSU and the second management information pertaining to the second DSU;
transmit the first aggregated management information;
a second module, when operable within the computing device, causes the computing device to:
generate second aggregated management information for a second set of DSUs affiliated with the first storage site;
receive the first aggregated management information;
generate third aggregated management information based on the first aggregated management information and the second aggregated management information; and
transmit the third aggregated management information to a third processing module, wherein the third processing module is configured to generate fourth aggregated management information based on the third aggregated management information and at least one additional management information pertaining to at least one additional DSU and further wherein the third processing module is affiliated with a second common storage site.

11. The DS module of claim 10, wherein the management information includes at least one of:
an amount of available remaining storage capacity in a DSU,
an amount of available remaining storage capacity in a set of DSUs,
an amount of available remaining storage capacity for storage in a storage site,
performance characteristics for a DSU,
performance characteristics for a set of DSUs,
performance characteristics for a storage site,
information sufficient to determine whether a DSU is incapacitated, and
information sufficient to determine whether a DSU is likely to become incapacitated.

12. The DS module of claim 10, wherein the first processing module is tasked with collecting management information pertaining to a set of DSUs.

13. The DS module of claim 10, wherein the second processing module is tasked with collecting management information pertaining to all DSUs in a storage site.

14. The DS module of claim 10, wherein the fourth aggregated management information includes management information associated with the first common storage site, the second common storage site and at least a third common storage site.

15. The DS module of claim 10, wherein the first management information and the second management information are both associated with a first storage pool, wherein the first storage pool includes a set of encoded data slices stored in a plurality of storage sites.

16. The DS module of claim 15, wherein the first management information, the second management and the third management information are associated with the first storage pool.

17. The DS module of claim 10, wherein first processing module is associated with a second DSU of the first set of dispersed storage units.

18. The DS module of claim 10, wherein first processing module is associated with a DSU of a second set of dispersed storage units located at the first common storage site.

19. A computing device comprising:
an interface configured to interface and communicate with a communication system;
memory that stores operational instructions; and
processing circuitry operably coupled to the interface and to the memory, wherein the processing circuitry is configured to execute the operational instructions to:
receive first management information pertaining to a first dispersed storage unit (DSU) of a first set of dispersed storage units (DSUs), wherein the first set of DSUs is affiliated with a first storage site; and
receive second management information pertaining to a second DSU of the first set of DSUs at a second processing module, wherein the second processing module is configured to generate second aggregated management information for a second set of DSUs, wherein the second set of DSUs is affiliated with the first storage site;
generate first aggregated management information based on the first management information pertaining to the first DSU and the second management information pertaining to the second DSU;
transmit the first aggregated management information to a second processing module;
generate second aggregated management information for a second set of DSUs affiliated with the first storage site;
receive the first aggregated management information;
generate third aggregated management information based on the first aggregated management information and the second aggregated management information; and
transmit the third aggregated management information to a third processing module, wherein the third processing module is configured to generate fourth aggregated management information based on the third aggregated management information and at least one additional management information pertaining to at least one additional DSU and further wherein the third processing module is affiliated with a second common storage site.

20. The computing device of claim 19, wherein the management information includes at least one of:
an amount of available remaining storage capacity in a DSU,
an amount of available remaining storage capacity in a set of DSUs,
an amount of available remaining storage capacity for storage in a storage site,
performance characteristics for a DSU,
performance characteristics for a set of DSUs,
performance characteristics for a storage site,
information sufficient to determine whether a DSU is incapacitated, and
information sufficient to determine whether a DSU is likely to become incapacitated.
